(19) United States
(12) Patent Application Publication
(10) Pub. No.: US 2017/0343514 A1
(43) Pub. Date: Nov. 30, 2017

(54) PIPING INSPECTION SYSTEM, PIPING INSPECTION DEVICE, PIPING INSPECTION METHOD, AND RECORDING MEDIUM

(71) Applicant: NEC Corporation, Minato-ku, Tokyo (JP)

(72) Inventors: Soichiro Takata, Tokyo (JP); Shohei Kinoshita, Tokyo (JP); Hirofumi Inoue, Tokyo (JP); Shigeki Shinoda, Tokyo (JP); Kenichiro Fujiyama, Tokyo (JP); Takahiro Kumura, Tokyo (JP); Shigeru Kasai, Tokyo (JP); Nobuhiro Mikami, Tokyo (JP)

(73) Assignee: NEC Corporation, Minato-ku, Tokyo (JP)

(21) Appl. No.: 15/537,943

(22) PCT Filed: Jan. 13, 2016
(86) PCT No.: PCT/JP2016/000149

§ 371 Date: Jun. 20, 2017

(30) Foreign Application Priority Data
Jan. 14, 2015 (JP) 2015-004676

(51) Int. Cl. G01N 29/04; G01H 13/00

(52) U.S. Cl. CPC G01N 29/045; G01H 13/00; G01N 29/048

(57) ABSTRACT

Degradation of a pipe can be easily detected. A piping inspection system 1 includes an excitation unit 100, a wave detection unit 210, and a diagnosis unit 220. The excitation unit 100 excites waves of different wave modes simultaneously at a first position of a pipe 300. The wave detection unit 210 detects the waves of different wave modes at a second position of the pipe 300. The diagnosis unit 220 diagnoses degradation of the pipe 300 based on a velocity of one of the waves of different wave modes, the velocity being calculated by using a detection time difference between the waves of different wave modes.

### TECHNICAL FIELD

The present invention relates to a piping inspection system, a piping inspection device, a piping inspection method, and a recording medium and in particular, relates to a piping inspection system, a piping inspection device, a piping inspection method, and a recording medium for detecting degradation of a pipe.

### BACKGROUND ART

An example of a technology for detecting degradation of a pipe is disclosed in, for example, PTL1. In the technology described in PTL 1, elastic wave transmission elements arranged along the circumferential direction of the pipe excite elastic waves that propagate in the axial direction or oblique directions of the pipe. Further, elastic wave reception elements receive the elastic wave that propagates in the axial direction or the oblique direction of the pipe. The elastic wave reception elements are arranged along the circumferential direction of the pipe at a position different from the position at which the elastic wave transmission elements are arranged. A pipe wall thickness is calculated based on an appearance time of the elastic wave in each direction that is received by the elastic wave reception element.

Further, as a related technology, PTL2 discloses a technology for exciting a longitudinal wave and a transverse wave in an ultrasonic transducer using a piezoelectric body. PTL3 discloses a technology for obtaining a thickness of an object to be measured by using a propagation time of a surface wave of the ultrasonic wave generated when the object to be measured is irradiated with a laser and a propagation time of a longitudinal wave or a transverse wave. PTL4 discloses a method for identifying a device not operating normally by using a correlation function between sound pressure signals of a plurality of devices. PTL5 discloses a technology for detecting a vibration of a building by using a three-axis acceleration sensor.

### CITATION LIST

### Patent Literature

[PTL1] Japanese Patent Application Laid-open Publication No. 2004-085370

[PTL2] Japanese Patent Application Laid-open Publication No. 2008-182515

[PTL3] Japanese Patent Application Laid-open Publication No. 2002-213936

[PTL4] Japanese Patent Application Laid-open Publication No. 2000-9048 [PTL5] Japanese Patent Application Laid-open Publication No.

### Non Patent Literature

[NPL1] Saneyoshi Junichi, “Ultrasonic Wave Technological Handbook, newly revised edition”, Nikkan Kogyo Shimbun Ltd., 1978, pp. 95

### SUMMARY OF INVENTION

### Technical Problem

In the technology described in the above-mentioned PTL1, in order to calculate the pipe wall thickness, the appearance time of the elastic wave in the reception element has to be measured while synchronizing the elastic wave transmission element with the elastic wave reception element. This raises an issue in that the system configuration becomes complicated.

An object of the present invention is to solve the above-mentioned issue and provide a piping inspection system, a piping inspection device, a piping inspection method, and a recording medium which can facilitate the detection of pipe degradation.

### Solution to Problem

A piping inspection system according to an exemplary aspect of the present invention includes: excitation means for exciting waves of different wave modes simultaneously at a first position of a pipe; wave detection means for detecting the waves of different wave modes at a second position of the pipe; and diagnosis means for diagnosing degradation of the pipe based on a velocity of one of the waves of different wave modes, the velocity being calculated by using a detection time difference between the waves of different wave modes.

A piping inspection device according to an exemplary aspect of the present invention includes: wave detection means for detecting waves of different wave modes at a second position of a pipe, the waves of different wave modes being excited simultaneously at a first position of the pipe; and diagnosis means for diagnosing degradation of the pipe based on a velocity of one of the waves of different wave modes, the velocity being calculated by using a detection time difference between the waves of different wave modes.

A piping inspection method according to an exemplary aspect of the present invention includes: exciting waves of different wave modes simultaneously at a first position of a pipe; detecting the waves of the different wave modes at a second position of the pipe; and diagnosing degradation of the pipe based on a velocity of one of the waves of different wave modes, the velocity being calculated by using a detection time difference between the waves of different wave modes.

A computer readable storage medium according to an exemplary aspect of the present invention records thereon a program causing a computer to perform a method including: detecting waves of different wave modes at a second position of a pipe, the waves of different wave modes being excited simultaneously at a first position of the pipe; and diagnosing degradation of the pipe based on a velocity of one of the waves of different wave modes, the velocity being calculated by using a detection time difference between the waves of different wave modes.

### Advantageous Effects of Invention

The present invention has an effect in which degradation of a pipe can be easily detected.

### BRIEF DESCRIPTION OF DRAWINGS

FIG. 1 is a block diagram illustrating a basic configuration of an example embodiment of the present invention.

FIG. 2 is a block diagram illustrating a configuration of a piping inspection system 1 according to the example embodiment of the present invention.

FIG. 3 is a block diagram illustrating a configuration of an inspection unit 200 realized by a computer according to the example embodiment of the present invention.

FIG. 4 is a diagram illustrating an example of a vibration direction in an excitation unit 100 and an installation direction of sensing axes of a wave sensor 211 according to the example embodiment of the present invention.

FIG. 5 is a flowchart illustrating operation according to the example embodiment of the present invention.

FIG. 6 is a graph illustrating a frequency dispersion property of a fluid structure coupled wave of a longitudinal wave in a pipe.

FIG. 7 is a graph illustrating a frequency dispersion property of a fluid structure coupled wave of a torsional wave in a pipe.

FIG. 8 is a graph illustrating a calculation result of estimated sound velocities in a first specific example of the example embodiment of the present invention.

FIG. 9 is a diagram illustrating a method for installing an excitation jig 102 in a second specific example of the example embodiment of the present invention.

### DESCRIPTION OF EMBODIMENTS

An example embodiment of the present invention will be described in detail with reference to drawings. A direction of an arrow in the drawings indicates one example and does not limit the example embodiment of the present invention.

First, a configuration of the example embodiment of the present invention will be described.

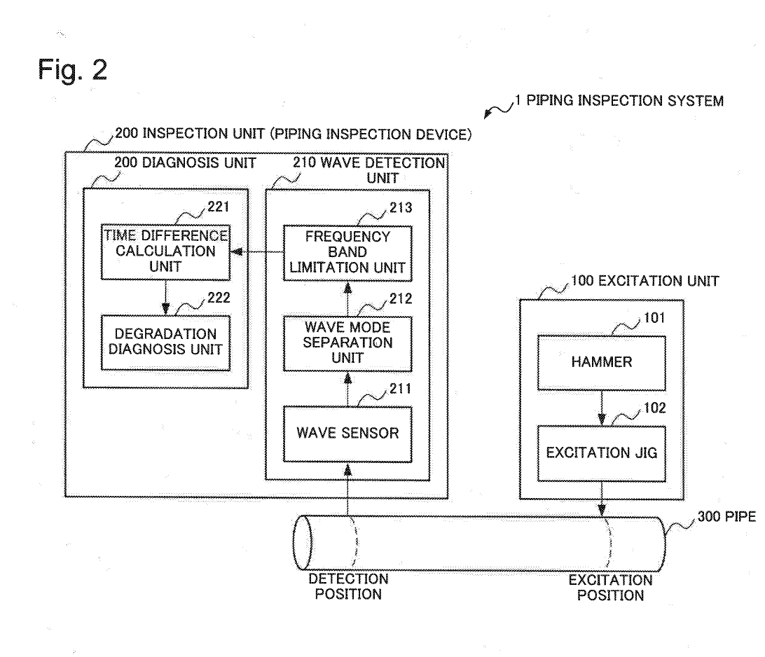

FIG. 2 is a block diagram illustrating a configuration of a piping inspection system 1 according to the example embodiment of the present invention. Referring to FIG. 2, the piping inspection system 1 includes an excitation unit 100 and an inspection unit 200 (or a piping inspection device).

The excitation unit 100 excites waves of a plurality of different wave modes (also described as stress waves or elastic waves) simultaneously at a certain position (an excitation position or a first position) of a pipe 300. In the example embodiment of the present invention, a longitudinal wave mode indicating a wave in an axial direction of the pipe 300 and a torsional wave (or a transverse wave) mode indicating a wave in a circumferential direction are used as the plurality of the wave modes. Hereinafter, a wave of the longitudinal wave mode and a wave of the torsional wave mode are described as a longitudinal wave and a torsional wave, respectively. As described later, for a longitudinal wave, there are a fluid prevailing mode and a longitudinal wave prevailing mode. In the example embodiment of the present invention, as the longitudinal wave, the longitudinal wave prevailing mode is used.

The excitation unit 100 includes a hammer 101 and an excitation jig 102. The excitation jig 102 is fixed on the pipe 300, and when a user or the like hits the excitation jig 102 with the hammer 101, the excitation jig 102 excites waves of the plurality of different wave modes. Here, the excitation jig 102 is, for example, a round bar made of material of material number A5052 specified by Japanese Industrial Standards (hereinafter, JIS). The hammer 101 is, for example, a hammer whose tip shape is hemispherical and made of material of material number SS400 specified by JIS.

The inspection unit 200 detects degradation of the pipe 300 by using an arrival time difference (detection time difference) between waves of different wave modes that are detected at a position (detection position or a second position) different from the above-mentioned excitation position of the pipe 300.

The inspection unit 200 includes a wave detection unit 210 and a diagnosis unit 220.

The wave detection unit 210 includes a wave sensor 211, a wave mode separation unit 212, and a frequency band limitation unit 213.

The wave sensor 211 detects waves of different wave modes at the above-mentioned detection position on the pipe 300 and outputs signals (hereinafter, referred to as detection signals) that represent the waves of respective different wave modes. For example, the wave sensor 211 is a piezoelectric three-axis acceleration sensor including a built-in constant current drive circuit.

The wave mode separation unit 212 outputs, from the detection signals outputted by the wave sensor 211, respective detection signals of the longitudinal wave and the torsional wave to be used for degradation diagnosis to the frequency band limitation unit 213. For example, the wave mode separation unit 212 is a dipswitch for outputting respective detection signals of the set wave modes (the longitudinal wave and the torsional wave) among the detection signals of respective wave modes outputted from the three-axis acceleration sensor.

The frequency band limitation unit 213 limits bands of the respective detection signals outputted by the wave mode separation unit 212 according to predetermined frequency characteristics. For example, the frequency band limitation unit 213 is a bandpass filter with a predetermined frequency characteristic that is composed of a resistor and a capacitor.

The diagnosis unit 220 includes a time difference calculation unit 221 and a degradation diagnosis unit 222.

The time difference calculation unit 221 calculates an arrival time difference between the longitudinal wave and the torsional wave based on the detection signals outputted by the frequency band limitation unit 213. Here, for example, the time difference calculation unit 221 may calculate the arrival time difference by obtaining a cross-correlation function indicating a cross-correlation between the detection signals of the longitudinal wave and the torsional wave. Further, the time difference calculation unit 221 may extract envelopes of the detection signals of the longitudinal wave and the torsional wave, and calculate the arrival time difference based on a time difference between the times at which the respective envelopes reach their maximum values.

The degradation diagnosis unit 222 calculates an estimation value (hereinafter, also described as an estimated sound velocity) of a sound velocity (hereinafter, described as a propagation velocity or a phase velocity) of a wave based on the arrival time difference calculated by the time difference calculation unit 221. The degradation diagnosis unit 222 diagnoses the degradation of the pipe 300 based on a result of comparison between the calculated estimated sound velocity and an estimated sound velocity when the pipe 300 is not degraded (in normal times).

Note that the inspection unit 200 (the piping inspection device) may be a computer that includes a CPU (Central Processing Unit) and a storage medium storing a program and operates by control based on the program.

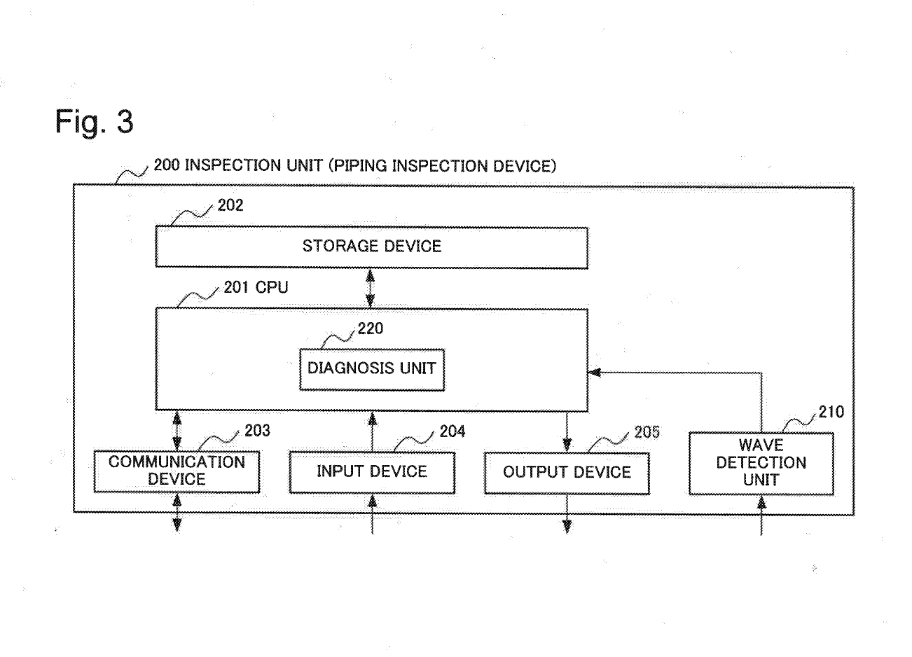

FIG. 3 is a block diagram illustrating a configuration of the inspection unit 200 realized by a computer according to the example embodiment of the present invention.

The inspection unit 200 includes a CPU 201, a storage device (a storage medium) 202 such as a hard disk, a memory, or the like, a communication device 203 which communicates with another device or the like, an input device 204 such as a mouse, a keyboard, or the like, an output device 205 such as a display or the like, and the wave detection unit 210.

The CPU 201 executes a computer program for implementing functions of the diagnosis unit 220. The storage device 202 stores the computer program. The input device 204 receives a diagnosis execution instruction from a user or the like. The output device 205 outputs a result of diagnosis to the user or the like. Further, the communication device 203 may receive the diagnosis execution instruction from another device or the like and output the result of diagnosis to the another device or the like.

Next, the operation of the example embodiment of the present invention will be described.

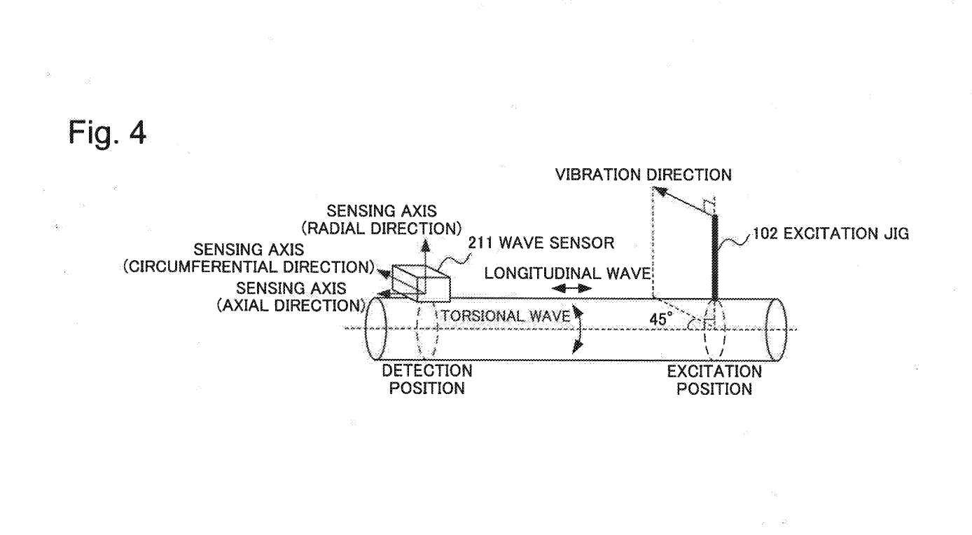

FIG. 4 is a diagram illustrating an example of a vibration direction in the excitation unit 100 and an installation direction of sensing axes of the wave sensor 211 according to the example embodiment of the present invention.

Here, it is assumed that the excitation jig 102 is the round bar mentioned above and one end thereof is fixed at the excitation position on the pipe 300. Further, it is assumed that the wave sensor 211 is a three-axis acceleration sensor, and as illustrated in FIG. 4, the wave sensor 211 is installed in such a way that one among the sensing axes is along the axial direction (the direction of the longitudinal wave) of the pipe 300 and the other is along the circumferential direction (the direction of the torsional wave) perpendicular to the axial direction of the pipe 300. Moreover, it is assumed that the wave mode separation unit 212 is a dipswitch and set in such a way as to output each of the detection signals of the longitudinal wave and the torsional wave. In this case, as illustrated in FIG. 4, it is desirable that the end (the other end) opposite to one end of the excitation jig 102 which is fixed on the pipe 300 is hit (vibrated) with the hammer 101 mentioned above in a direction perpendicular to the excitation jig 102 and in a direction of 45 degrees from the axial direction of the pipe 300. As a result, waves of the longitudinal wave and the torsional wave are excited simultaneously at the excitation position of the pipe 300.

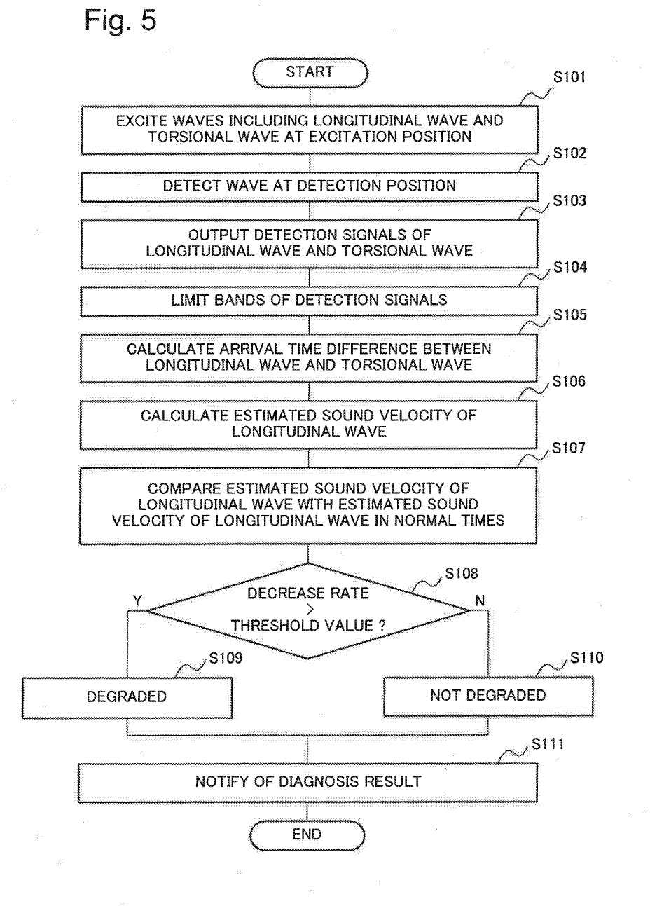

FIG. 5 is a flowchart illustrating operation according to the example embodiment of the present invention.

First, the excitation jig 102 of the excitation unit 100 excites waves including the longitudinal wave and the torsional wave at the excitation position of the pipe 300 (step S101). For example, the excitation jig 102 is vibrated in the vibration direction as illustrated in FIG. 4.

The wave sensor 211 of the wave detection unit 210 detects the waves of the different wave modes at the detection position on the pipe 300 and outputs detection signals of the respective different wave modes (step S102).

The wave mode separation unit 212 outputs, from the detection signals outputted by the wave sensor 211, respective detection signals of the longitudinal wave and the torsional wave (step S103).

The frequency band limitation unit 213 limits bands of the respective detection signals of the longitudinal wave and the torsional wave according to predetermined frequency characteristics (step S104).

The time difference calculation unit 221 of the diagnosis unit 220 calculates an arrival time difference At between the longitudinal wave and the torsional wave based on a cross-correlation function between the respective band-limited detection signals of the longitudinal wave and the torsional wave (step S105).

The degradation diagnosis unit 222 calculates an estimated sound velocity of the longitudinal wave from the arrival time difference At (step S106).

A sound velocity V_{z} of the longitudinal wave and a sound velocity V_{θ} of the torsional wave in the pipe 300 are expressed by Equation 1.

$${V}_{z} = \sqrt{\frac{E}{ρ}} \\ {V}_{θ} = \sqrt{\frac{G}{ρ}} \\ G = \frac{E}{2 ( 1 + v )} \qquad [ Equation 1 ]$$

In Equation 1, E, G, ρ, and v are an elastic modulus, a modulus of transverse elasticity, a density, and a Poisson's ratio of the pipe 300, respectively.

The arrival time difference Δt between the longitudinal wave and the torsional wave can be expressed by Equation 2 using the sound velocity V_{z} of the longitudinal wave and the sound velocity V_{θ} of the torsional wave.

$$Δ t = \frac{L}{{V}_{θ}} - \frac{L}{{V}_{z}} \qquad [ Equation 2 ]$$

In Equation 2, L is a distance between the excitation position and the detection position. When the Poisson's ratio v is smaller than 1 at a certain extent, the arrival time difference At calculated by Equation 2 is approximated by Equation 3 within a certain degree of error range.

$$Δ t \approx ( \sqrt{2} - 1 ) \frac{L}{{V}_{z}} \qquad [ Equation 3 ]$$

Accordingly, the sound velocity V_{z} of the longitudinal wave can be estimated by Equation 4 using the arrival time difference Δt and the distance L between the excitation position and the detection position.

$${V}_{z} = ( \sqrt{2} - 1 ) \frac{L}{Δ t} \qquad [ Equation 4 ]$$

The degradation diagnosis unit 222 compares the estimated sound velocity of the longitudinal wave calculated in step S 106 with an estimated sound velocity of the longitudinal wave in normal times (step S107). The degradation diagnosis unit 222 determines whether or not the pipe 300 is degraded based on a result of the comparison.

Here, it is observed that, with the degradation of the pipe 300, the elastic modulus E of the pipe 300 decreases and the decrease in the density p due to the degradation of the pipe 300 is sufficiently smaller than the decrease in the elastic modulus E. Accordingly, from Equation 1, when the pipe 300 is degraded, the sound velocity V_{z} of the longitudinal wave and the sound velocity V_{θ} of the torsional wave decrease.

In a case that a decrease rate of the estimated sound velocity calculated in step S106 from the estimated sound velocity in normal times exceeds a predetermined threshold value (Yes in step S108), the degradation diagnosis unit 222 determines that the pipe 300 is “degraded” (step S109). On the other hand, when the decrease rate is equal to or smaller than the predetermined threshold value (No in step S108), the degradation diagnosis unit 222 determines that the pipe 300 is “not degraded” (step S110).

The degradation diagnosis unit 222 notifies the user or the like of a result of diagnosis through the output device 205 (step S111).

As described above, the operation of the example embodiment of the present invention is completed.

Next, frequency characteristics of waves used for degradation detection will be described.

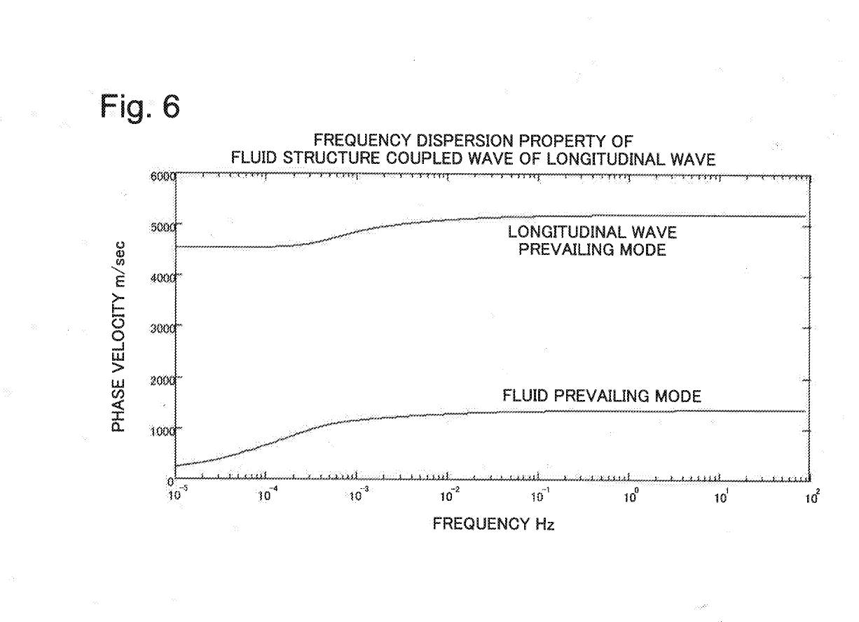

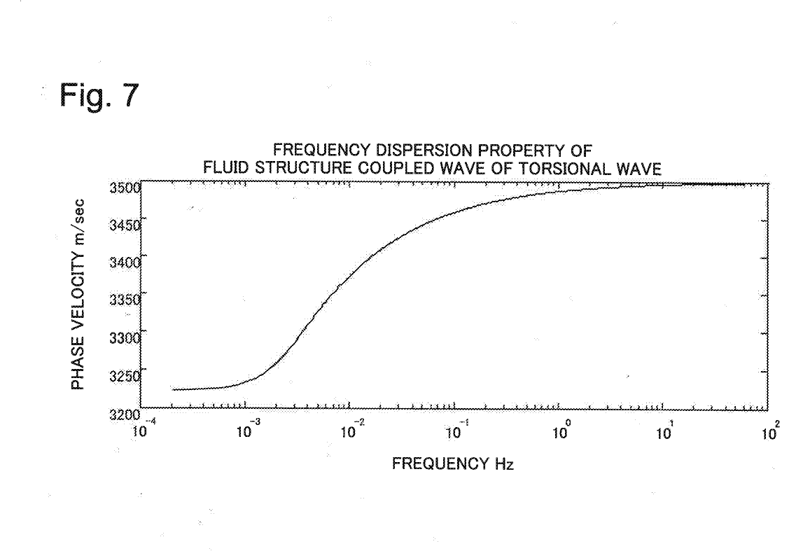

In the actual pipe 300, fluid in the pipe 300 has an influence on elastic waves of the pipe 300. Accordingly, frequency dispersion properties of phase velocities of the longitudinal wave and the torsional wave can be theoretically obtained by strongly coupling an equation of motion of an elastic body of the pipe with a Navier-Stokes equation of the fluid. FIG. 6 and FIG. 7 are graphs illustrating the frequency dispersion property of a fluid structure coupled wave of the longitudinal wave and the frequency dispersion property of a fluid structure coupled wave of the torsional wave in the pipe, which are theoretically obtained by using the above-mentioned method, respectively. In FIG. 6 and FIG. 7, the horizontal axis indicates frequency and the vertical axis indicates phase velocity. Here, the following values are used: an elastic modulus is 209 GPa; a Poisson's ratio is 0.3, a pipe density is 7800 kg/m³; a water density is 999 kg/m³; a volume elastic modulus is 2.1 GPa, a kinematic viscosity is 1.0 μm²/s; and a viscosity coefficient of fluid is 0.001 Pa·s.

FIG. 6 illustrates the frequency dispersion property of the coupled wave of the longitudinal wave and the fluid of an elastic pipe. The frequency dispersion characteristic of the longitudinal wave is dominated mainly by two wave modes. One is a fluid prevailing mode similar to a wave mode that the fluid has and the other is a longitudinal wave prevailing mode similar to the longitudinal wave of the pipe 300. As illustrated in FIG. 6, in both modes, large frequency dispersion occurs in a frequency band of 1 Hz or less, and the phase velocity decreases.

Further, FIG. 7 illustrates the frequency dispersion property of the coupled wave of the torsional wave and the fluid. As illustrated in FIG. 7, with respect to the torsional wave, large frequency dispersion occurs in a frequency band of 1 Hz or less and the phase velocity decreases.

On the other hand, for example, in NPL 1, it is disclosed that when a radius of the pipe is approximately equal to a wavelength, the dispersion occurs in a high-frequency side. When a sound velocity in the pipe is 5000 m/s, a wavelength is 1 m at a frequency of 5 kHz.

When the frequency dispersion occurs, an arrival time of a wave changes according to a frequency thereof and a calculation accuracy of the arrival time difference Δt decreases. Accordingly, when calculating the arrival time difference between the waves of different modes, it is desirable that a band of a detection signal is limited within a frequency band of 1 Hz to 1 kHz by the frequency band limitation unit 213.

In the example embodiment of the present invention, a velocity of the longitudinal wave is calculated by using the arrival time difference. Alternatively, a velocity of the torsional wave may be calculated instead of the velocity of the longitudinal wave and the degradation of the pipe 300 may be diagnosed based on the velocity of the torsional wave.

In the example embodiment of the present invention, as a combination of different wave modes, a combination of the longitudinal wave (the longitudinal wave prevailing mode) and the torsional wave is used. Alternatively, another combination of waves among the longitudinal wave (the fluid prevailing mode), the longitudinal wave (the longitudinal wave prevailing mode), and the torsional wave may be used, as long as a velocity of a wave can be calculated based on an arrival time difference.

In the example embodiment of the present invention, waves of different wave modes are excited by hitting the excitation jig 102 fixed at the excitation position on the pipe 300 with the hammer 101 in the excitation unit 100. Alternatively the excitation may be performed by using an elastic wave transmission element or the like at the excitation position on the pipe 300, as long as waves of different wave modes can be excited simultaneously.

Next, a specific example of the example embodiment of the present invention will be described.

First, as a first specific example, a result of a test in which a pipe is artificially degraded will be described.

Here, a carbon steel tube for piping that is corroded by electric corrosion is used as the pipe 300. The size of the pipe 300 is as follows: an inside diameter of the pipe 300 is 42 mm; a pipe wall thickness is 8 mm;

and a pipe length is 2 m. The electric corrosion process is performed as follows: an outer diameter part of the pipe 300 is covered with a vinyl tape; an inner diameter part of the pipe is soaked in 3% NaCl aqueous solution; a copper plate is used as an anode electrode; the pipe 300 is used as a cathode electrode; and an electric current is made to flow from a constant-current source. As a condition for the electric corrosion, the following condition is used: an electric current is 3 A; a time length for supplying the current (corrosion time) is 25 minutes, 60 minutes, or 120 minutes.

An arrival time difference between the longitudinal wave and the torsional wave is measured for a normal pipe 300 (the corrosion time is 0 minute) and degraded pipes 300 that are corroded by the electric corrosion under the respective electric corrosion conditions. Water is used as fluid in the pipe 300 and both ends of the pipe 300 are closed. An impulse hammer whose tip is made of steel is used as the hammer 101. A three-axis acceleration sensor including a built-in 4mA constant current drive circuit is used as the wave sensor 211, and the sensor is installed at one end of the pipe 300 in such a way that acceleration in the axial direction of the pipe 300 can be measured by one axis of the three-axis acceleration sensor and acceleration in the circumferential direction and acceleration in the radial direction of the pipe 300 can be measured by the other axes thereof. The A/D (analog/digital) conversion with 12 bits is performed for detection signals of the sensor, the converted signals are respectively sampled at a sampling frequency of 10 MHz, and the sampled signals are measured by a digital oscilloscope with a one-side voltage range of 500 mV. A rod-shaped jig is used as the excitation jig 102 and one end thereof is fixed to the other end of the pipe 300 in such a way as to be perpendicular to the axial direction of the pipe 300. The other end of the jig is vibrated with the impulse hammer mentioned above in a direction perpendicular to the jig and in a direction of 45 degrees from the axial direction of the pipe 300. In this case, a wave of the longitudinal wave is detected in the axial direction of the sensor and a wave of the torsional wave is detected in the circumferential direction of the sensor.

Here, an arrival time difference obtained by the cross correlation function for the longitudinal wave and the torsional wave detected for the normal pipe 300 (the corrosion time is 0 minute) is 0.1756 msec. This value is very close to a time difference of 0.1576 msec calculated by Equation.3.

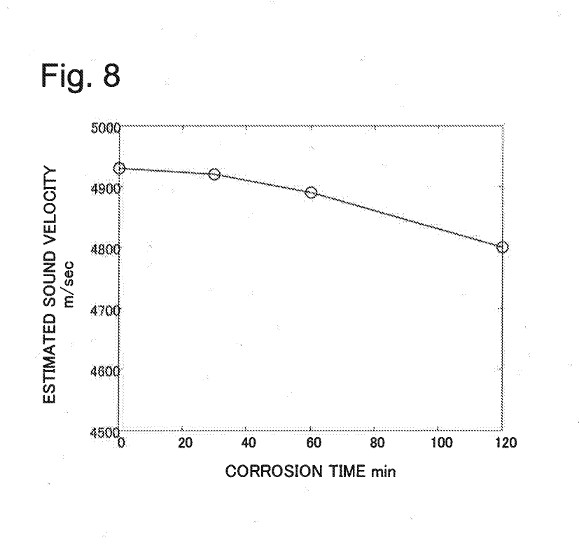

Further, arrival time differences are obtained similarly and estimated sound velocities are calculated for the longitudinal wave and the torsional wave detected for the degraded pipes 300 that are corroded under the respective electric corrosion conditions (the corrosion time is 25 minutes, 60 minutes, or 120 minutes). FIG. 8 is a graph illustrating a calculation result of the estimated sound velocities in the first specific example of the example embodiment of the present invention. In FIG. 8, the horizontal axis indicates a corrosion time of each of the corrosion conditions and the vertical axis indicates an estimated sound velocity calculated by Equation 4. As illustrated in FIG. 8, the estimated sound velocity decreases as the corrosion time increases. The estimated sound velocity of the pipe 300 corroded with the corrosion time of 120 minutes decreases by 2.63% from the estimated sound velocity in normal times (the corrosion time is 0 minute). Therefore, the degradation of the pipe 300 due to the corrosion can be correctly determined by using the decrease rate threshold value of 2.5%, for example.

Next, as a second specific example, a result of the test in which an actual buried pipe is used will be described.

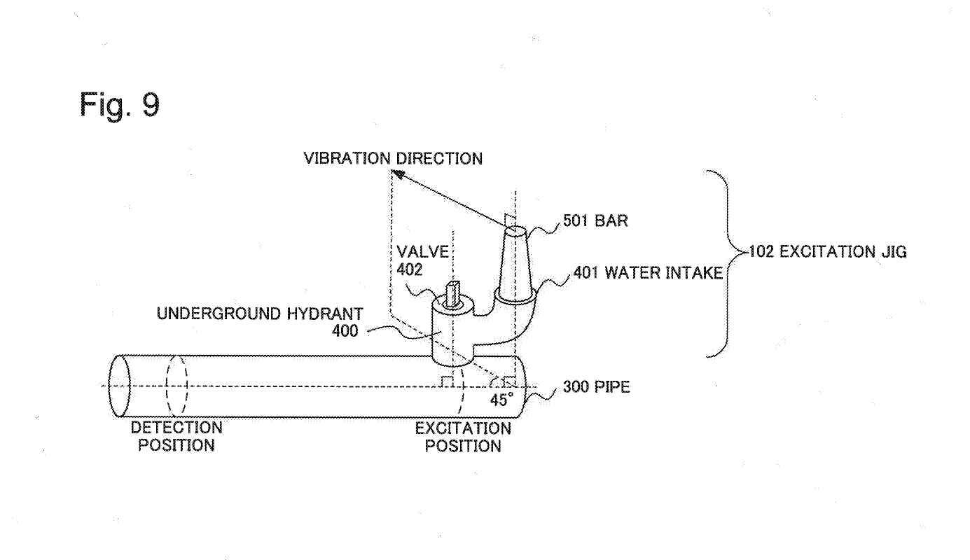

FIG. 9 is a diagram illustrating a method for installing the excitation jig 102 in the second specific example of the example embodiment of the present invention.

Here, a carbon steel tube for piping whose nominal diameter specified by JIS is 50 A is buried at depth of 3 m in the ground and used as the pipe 300. Water is used as fluid in the pipe 300, a distance between the excitation position and the detection position is 70 m, and both ends of the pipe 300 are opened. Further, an impulse hammer whose tip is made of a steel is used as the hammer 101. A three-axis acceleration sensor including a built-in 4mA constant current drive circuit is used as the wave sensor 211, and the sensor is installed at the detection position in such a way that acceleration in the axial direction of the pipe 300 can be measured by one axis of the three-axis acceleration sensor and accelerations in the circumferential direction and accelerations in the radial direction of the pipe 300 can be measured by the other axes thereof. The A/D conversion with 16 bits is performed for detection signals of the sensor, the converted signals are respectively sampled at a sampling frequency of 20 KHz, and the sampled signals are measured by an FFT (Fast Fourier Transform) analyzer with a one-side voltage range of 14.1 mV. As illustrated in FIG. 9, as the excitation jig 102, a trapezoidal cone-shaped bar 501 (a tapered bar 501 with circular cross-section) is fixed on an underground hydrant 400 that is vertically attached to the pipe 300 at the excitation position of the pipe 300. One end (the lower base face) of the bar 501 is fixed on a water intake 401 of the underground hydrant 400 by Machino-type metal fitting. The water intake 401 is installed along the axial direction of the underground hydrant 400 from a valve 402. Namely, the jig is installed along the axial direction of the hydrant. The bar 501 is formed in a tapered shape of which a diameter of one end (the lower base face) is 95 mm, the diameter of the other end (the upper base face) is 63 mm, and a ratio of two diameters is 2/3. The bar 501 is solid and made of material of material number A5052 specified by JIS. With this shape, the weight of the bar 501 can be reduced, and a force can be transmitted to the pipe 300 equally in each cross-section surface in the longitudinal direction of the bar 501 through the underground hydrant 400 without loss. The other end (the upper base face) of the bar 501 is vibrated with the impulse hammer mentioned above in a direction perpendicular to the bar 501 and in a direction of 45 degrees from the axial direction of the pipe 300. In this case, a wave of the longitudinal wave is detected in the axial direction of the sensor and a wave of the torsional wave is detected in the circumferential direction of the sensor.

Here, an arrival time difference obtained by the cross correlation function for the longitudinal wave and the torsional wave detected for the pipe 300 is 4.45 msec. This value is very close to a time difference of 5.8 msec calculated by Equation.3. Therefore, degradation of the actual buried pipe due to the corrosion can be correctly determined.

In the above-mentioned specific example, the bar 501 is fixed on the underground hydrant 400 that is connected to the pipe 300 at the excitation position of the pipe 300. Similarly, the wave sensor 211 may be installed on the underground hydrant that is connected to the pipe 300 at the detection position of the pipe 300 in such a way that acceleration in the axial direction and acceleration in the circumferential direction of the pipe 300 can be measured.

Next, a basic configuration of the example embodiment of the present invention will be described.

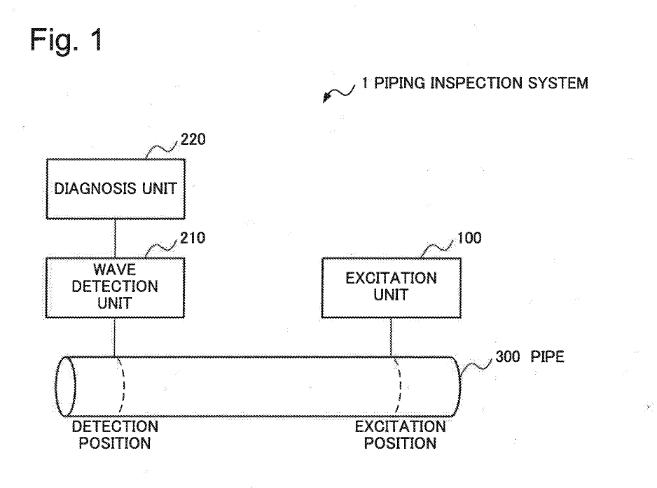

FIG. 1 is a block diagram illustrating a basic configuration of the example embodiment of the present invention. Referring to FIG. 1, a piping inspection system 1 includes an excitation unit 100, a wave detection unit 210, and a diagnosis unit 220. The excitation unit 100 excites waves of different wave modes simultaneously at a first position of a pipe 300. The wave detection unit 210 detects the waves of different wave modes at a second position of the pipe 300. The diagnosis unit 220 diagnoses degradation of the pipe 300 based on a velocity of one of the waves of different wave modes. The velocity is calculated by using a detection time difference between the waves of different wave modes.

Next, an effect of the example embodiment of the present invention will be described.

According to the example embodiment of the present invention, degradation of the pipe can be easily detected. This is because waves of different wave modes are excited simultaneously at the first position of the pipe, the waves of the different wave modes are detected at the second position, and the degradation of the pipe is diagnosed based on a velocity of the wave. The velocity is calculated by using a detection time difference between the detected waves.

As a result, it is not necessary to synchronize an excitation unit and a detection unit for a wave, and the system can be easily configured at low cost.

Further, in the technology described in PTL1, in order to excite and detect a wave on the pipe, an excitation unit and a detection unit need to be installed around the pipe. Therefore, it is difficult to apply the technology to the buried pipe. According to the example embodiment of the present invention, the underground hydrant or the like connected to the pipe can be used as a part of the excitation unit and the detection unit. Accordingly, this example embodiment of the present invention can be easily applied to the buried pipe.

While the present invention has been particularly shown and described with reference to the example embodiments thereof, the present invention is not limited to the embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2015-004676, filed on Jan. 14, 2015, the disclosure of which is incorporated herein in its entirety by reference.

### REFERENCE SIGNS LIST

100 excitation unit
101 hammer
102 excitation jig
200 inspection unit
201 CPU
202 storage device
203 communication device
204 input device
205 output device
210 wave detection unit
211 wave sensor
212 wave mode separation unit
213 frequency band limitation unit
220 diagnosis unit
221 time difference calculation unit
222 degradation diagnosis unit
300 pipe
400 underground hydrant
401 water intake
402 valve
501 bar

What is claimed is:

1. A piping inspection system comprising:
an excitation unit that excites waves of different wave modes simultaneously at a first position of a pipe;
a memory storing instructions; and
one or more processors configured to execute the instructions to:
detect the waves of different wave modes at a second position of the pipe; and
diagnose degradation of the pipe based on a velocity of one of the waves of different wave modes, the velocity being calculated by using a detection time difference between the waves of different wave modes.

2. The piping inspection system according to claim 1, wherein
the degradation of the pipe is diagnosed based on an amount of change from a velocity in normal times to the velocity calculated.

3. The piping inspection system according to claim 1, wherein the different wave modes are a longitudinal wave mode indicating a wave in an axial direction of the pipe and a torsional wave mode indicating a wave in a circumferential direction of the pipe.

4. The piping inspection system according to claim 3, wherein
the excitation unit is rod-shaped, one end of the excitation unit is fixed on the pipe in such a way as to be approximately perpendicular to the axial direction of the pipe, and the waves of different wave modes are simultaneously excited when part close to another end of the excitation unit is hit and vibrated in a direction approximately perpendicular to the excitation unit and in a direction of approximately 45 degrees from the axial direction of the pipe.

5. The piping inspection system according to claim 4, wherein
the excitation unit includes a hydrant connected to the pipe in such a way as to be approximately perpendicular to the axial direction of the pipe and a bar fixed on the hydrant in an approximately axial direction of the hydrant.

6. The piping inspection system according to claim 5, wherein
a cross-section of the bar is circular, and the bar is tapered in such a way that a diameter of one end that is not fixed on the hydrant is two third of a diameter of another end that is fixed on the hydrant.

7. The piping inspection system according to claim 1, wherein
a wave of a frequency from 1 Hz to 1 kHz is detected for each of the different wave modes.

8. A piping inspection device comprising:
a memory storing instructions; and
one or more processors configured to execute the instructions to:
detect waves of different wave modes at a second position of a pipe, the waves of different wave modes being excited simultaneously at a first position of the pipe; and
diagnose degradation of the pipe based on a velocity of one of the waves of different wave modes, the velocity being calculated by using a detection time difference between the waves of different wave modes.

9. A piping inspection method comprising:
exciting waves of different wave modes simultaneously at a first position of a pipe;
detecting the waves of the different wave modes at a second position of the pipe; and
diagnosing degradation of the pipe based on a velocity of one of the waves of different wave modes, the velocity being calculated by using a detection time difference between the waves of different wave modes.

10. (canceled)
